(19) United States
(12) Patent Application Publication
(10) Pub. No.: US 2019/0056235 A1
(43) Pub. Date: Feb. 21, 2019

(54) PATH QUERYING METHOD AND DEVICE, AN APPARATUS AND NON-VOLATILE COMPUTER STORAGE MEDIUM

(71) Applicant: BAIDU ONLINE NETWORK TECHNOLOGY (BEIJING) CO., LTD., Haidian District Beijing (CN)

(72) Inventor: Feng LIU, Haidian District Beijing (CN)

(73) Assignee: BAIDU ONLINE NETWORK TECHNOLOGY (BEIJING) CO., LTD., Haidian District Beijing (CN)

(21) Appl. No.: 15/765,204

(22) PCT Filed: Dec. 22, 2015
(86) PCT No.: PCT/CN2015/098278

§ 371 Date: Mar. 30, 2018

(30) Foreign Application Priority Data
Sep. 30, 2015 (CN) 201510639503.8

(51) Int. Cl. G01C 21/34; G01C 21/36

(52) U.S. Cl. CPC G01C 21/3492; G01C 21/3667; G01C 21/3617

(57) ABSTRACT

Path querying method, apparatus and non-volatile computer storage medium which acquires search data having a departure and a destination location; obtains according to the search data, M road segment sequences each including at least one road segment; selecting, according to a transition probability of each road segment of the at least one road segment included in respective road segment sequences, N road segment sequences from the M road segment sequences to be a route search result, wherein the transition probability of a road segment describes the probability of reaching the destination by turning to a neighboring segment of the road segment; and outputting the route search result. The disclosure does not rely on weights of roads to perform route search operation, and thus prevents obtaining an unreasonable search result due to inability to update the road weights in a timely manner, thereby improving the reliability of the route search operation.

The present disclosure claims the benefit of priority from the Chinese patent application No. 201510639503.8 entitled “Path Querying Method and Device” filed on Sep. 30, 2015, the disclosure of which is hereby incorporated by reference in its entirety.

### FIELD OF THE DISCLOSURE

The present disclosure relates to querying technology, and particularly to a path querying method and device, an apparatus and a non-volatile computer storage medium.

### BACKGROUND OF THE DISCLOSURE

With the development of communication technology, a terminal increasingly integrates functions so that a system function listing of the terminal includes more and more corresponding applications (APPs). Some applications involve some path querying services, for example, Baidu map. These applications first display a path querying interface to a user for input by the user. Then, according to the information input by the user, query endpoint information can be set, such as information of endpoints like a departure location and a destination, and then a query engine is requested to provide path data. The query engine may execute a path querying operation based on an urban road network and road weights of roads in the urban road network.

However, in some cases, for example, some factors affecting changes of the road weights, such as road width and road surface quality, might change at any time. The road weights of some roads might not be updated in time so that query results obtained from the path querying operations depending on the road weights might be unreasonable, for example, the query results are not optimal query results, or even might be undesirable query results, thereby causing fall of reliability of the path querying operations.

### SUMMARY OF THE DISCLOSURE

A plurality of aspects of the present disclosure provide a path querying method and device, an apparatus and a non-volatile computer storage medium, to improve reliability of a path querying operation.

According to an aspect of the present disclosure, there is provided a path querying method, comprising:

obtaining query data which include a departure location and a destination;

obtaining M road segment sequences according to the query data, each road segment sequence in the M road segment sequences comprising at least one road segment, M being an integer larger than or equal to 2;

selecting N road segment sequences from the M road segment sequences as path query results according to a turn probability from each road segment in the at least one road segment included in said each road segment sequence to the road segment's neighboring road segment which is accessible to the destination, N being an integer larger than or equal to 1 and less than or equal to M;

outputting the path query results.

The above aspect and any possible implementation mode further provide an implementation mode: before selecting N road segment sequences from the M road segment sequences as path query results according to a turn probability from each road segment in the at least one road segment included in said each road segment sequence to the road segment's neighboring road segment which is accessible to the destination, the method further comprises:

obtaining at least one user historical trajectory for reaching the destination according to the destination;

obtaining a historical road segment sequence corresponding to each user historical trajectory in the at least one user historical trajectory;

according to the historical road segment sequence corresponding to said each user historical trajectory, obtaining a number of first trajectories of passing each road segment included in the historical road segment sequence, and a number of second trajectories of passing the road segment and then passing each neighboring road segment of the road segment; and

according to the number of first trajectories and the number of second trajectories, obtaining a turn probability from each road segment included in the historical road segment sequence to the road segment's each neighboring road segment which is accessible to the destination.

The above aspect and any possible implementation mode further provide an implementation mode: the obtaining at least one user historical trajectory for reaching the destination according to the destination comprises:

obtaining an urban road network region to which the destination belongs according to the destination; and

according to the urban road network region to which the destination belongs, obtaining at least one user historical trajectory for reaching the urban road network region to which the destination belongs, as at least one user historical trajectory for reaching the destination.

The above aspect and any possible implementation mode further provide an implementation mode: before obtaining an urban road network region to which the destination belongs according to the destination, the method further comprises: dividing the urban road network with a designated spacing to generate several urban road network regions in the urban road network.

The above aspect and any possible implementation mode further provide an implementation mode: the selecting N road segment sequences from the M road segment sequences as path query results according to a turn probability from each road segment in the at least one road segment included in said each road segment sequence to the road segment's neighboring road segment which is accessible to the destination comprises:

obtaining a combined probability of said each road segment sequence according to the turn probability from each road segment in the at least one road segment included in said each road segment sequence to the road segment's neighboring road segment which is accessible to the destination;

selecting N road segment sequences from the M road segment sequences as the path query results according to the combined probability of said each road segment sequence.

The above aspect and any possible implementation mode further provide an implementation mode: the selecting N road segment sequences from the M road segment sequences as the path query results according to the combined probability of said each road segment sequence comprises:

considering N road segment sequences with a maximum combined probability as the path query results: or considering a road segment sequence whose combined probability is larger than or equal to a preset probability threshold, as one road segment sequence in the N road segment sequences.

According to another aspect of the present disclosure, there is provided a path querying device, comprising:

an obtaining unit configured to obtain query data which include a departure location and a destination;

a matching unit configured to obtain M road segment sequences according to the query data, each road segment sequence in the M road segment sequences comprising at least one road segment, M being an integer larger than or equal to 2;

a selecting unit configured to select N road segment sequences from the M road segment sequences as path query results according to a turn probability from each road segment in the at least one road segment included in said each road segment sequence to the road segment's neighboring road segment which is accessible to the destination, N being an integer larger than or equal to 1 and less than or equal to M;

an outputting unit configured to output the path query results.

The above aspect and any possible implementation mode further provide an implementation mode: the path querying apparatus further comprises a processing unit configured to

obtain at least one user historical trajectory for reaching the destination according to the destination;

obtain a historical road segment sequence corresponding to each user historical trajectory in the at least one user historical trajectory;

according to the historical road segment sequence corresponding to said each user historical trajectory, obtain a number of first trajectories of passing each road segment included in the historical road segment sequence, and a number of second trajectories of passing the road segment and then passing each neighboring road segment of the road segment; and

according to the number of first trajectories and the number of second trajectories, obtain a turn probability from each road segment included in the historical road segment sequence to the road segment's each neighboring road segment which is accessible to the destination.

The above aspect and any possible implementation mode further provide an implementation mode: the processing unit is specifically configured to

obtain a urban road network region to which the destination belongs according to the destination; and

according to the urban road network region to which the destination belongs, obtain at least one user historical trajectory for reaching the urban road network region to which the destination belongs, as at least one user historical trajectory for reaching the destination.

The above aspect and any possible implementation mode further provide an implementation mode: the path querying apparatus further comprises a dividing unit configured to

divide the urban road network with a designated spacing to generate several urban road network regions in the urban road network.

The above aspect and any possible implementation mode further provide an implementation mode: the selecting unit is specifically configured to

obtain a combined probability of said each road segment sequence according to a turn probability from each road segment in the at least one road segment included in said each road segment sequence to the road segment's neighboring road segment which is accessible to the destination, and

select N road segment sequences from the M road segment sequences as the path query results according to the combined probability of said each road segment sequence.

The above aspect and any possible implementation mode further provide an implementation mode: the selecting unit is specifically configured to

consider N road segment sequences with a maximum combined probability as the path query result; or

consider a road segment sequence whose combined probability is larger than or equal to a preset probability threshold, as one road segment sequence in the N road segment sequences.

According to a further aspect of the present disclosure, there is provided a device, comprising

one or more processors.

a memory;

one or more programs stored in the memory and configured to execute the following operations when executed by the one or more processors:

obtaining query data which include a departure location and a destination;

obtaining M road segment sequences according to the query data, each road segment sequence in the M road segment sequences comprising at least one road segment, M being an integer larger than or equal to 2;

selecting N road segment sequences from the M road segment sequences as path query results according to a turn probability from each road segment in the at least one road segment included in said each road segment sequence to the road segment's neighboring road segment which is accessible to the destination, N being an integer larger than or equal to 1 and less than or equal to M;

outputting the path query results.

According to a further aspect of the present disclosure, there is provided a non-volatile computer storage medium in which one or more programs are stored, an apparatus being enabled to execute the following operations when said one or more programs are executed by the apparatus:

obtaining query data which include a departure location and a destination;

obtaining M road segment sequences according to the query data, each road segment sequence of the M road segment sequences comprising at least one road segment, M being an integer larger than or equal to 2;

selecting N road segment sequences from the M road segment sequences as path query results according to a turn probability from each road segment in the at least one road segment included in said each road segment sequence to the road segment's neighboring road segment which is accessible to the destination, N being an integer larger than or equal to 1 and less than or equal to M;

outputting the path query results.

As known from the above technical solutions, in the embodiments of the present disclosure, the query data comprising the departure location and the destination are obtained, and then the M road segment sequences are obtained according to the query data so that according to the turn probability from each road segment in the at least one road segment included in said each road segment sequence to the road segment's neighboring road segment which is accessible to the destination, N road segment sequences can be selected from the M road segment sequences as the path query results. Since the query-querying operation is performed without depending on the road weights, this can avoid the problem in the prior art about unreasonable query results because the road weights of some roads cannot be updated in time, thereby improving the reliability of the path querying operation.

In addition, since the user historical trajectory as trajectory big data is employed to execute the path querying operation, the technical solution provided by the present disclosure can be employed to find the user's empirical route, provide more reasonable query results, for example, find a new road, or shun congested road, and substantially improve the user's experience.

### BRIEF DESCRIPTION OF DRAWINGS

To describe technical solutions of embodiments of the present disclosure more clearly, figures to be used in the embodiments or in depictions regarding the prior art will be described briefly. Obviously, the figures described below are only some embodiments of the present disclosure. Those having ordinary skill in the art appreciate that other figures may be obtained from these figures without making inventive efforts.

FIG. 1 is a flow chart of a path querying method according to an embodiment of the present disclosure;

FIG. 2 is a block diagram of a path querying apparatus according to another embodiment of the present disclosure;

FIG. 3 is a block diagram of a path querying apparatus according to a further embodiment of the present disclosure;

FIG. 4 is a block diagram of a path querying apparatus according to a further embodiment of the present disclosure.

### DETAILED DESCRIPTION OF PREFERRED EMBODIMENTS

To make objectives, technical solutions and advantages of embodiments of the present disclosure clearer, technical solutions of embodiment of the present disclosure will be described clearly and completely with reference to figures in embodiments of the present disclosure. Obviously, embodiments described here are partial embodiments of the present disclosure, not all embodiments. All other embodiments obtained by those having ordinary skill in the art based on the embodiments of the present disclosure, without making any inventive efforts, fall within the protection scope of the present disclosure.

It needs to be appreciated that the terminals involved in the embodiments of the present disclosure comprise but are not limited to a mobile phone, a Personal Digital Assistant (PDA), a wireless handheld device, a tablet computer, a Personal Computer (PC), an MP3 player, an MP4 player, and a wearable device (e.g., a pair of smart glasses, a smart watch, or a smart bracelet).

In addition, the term “and/or” used in the text is only an association relationship depicting associated objects and represents that three relations might exist, for example, A and/or B may represents three cases, namely, A exists individually, both A and B coexist, and B exists individually. In addition, the symbol “/” in the text generally indicates associated objects before and after the symbol are in an “or” relationship.

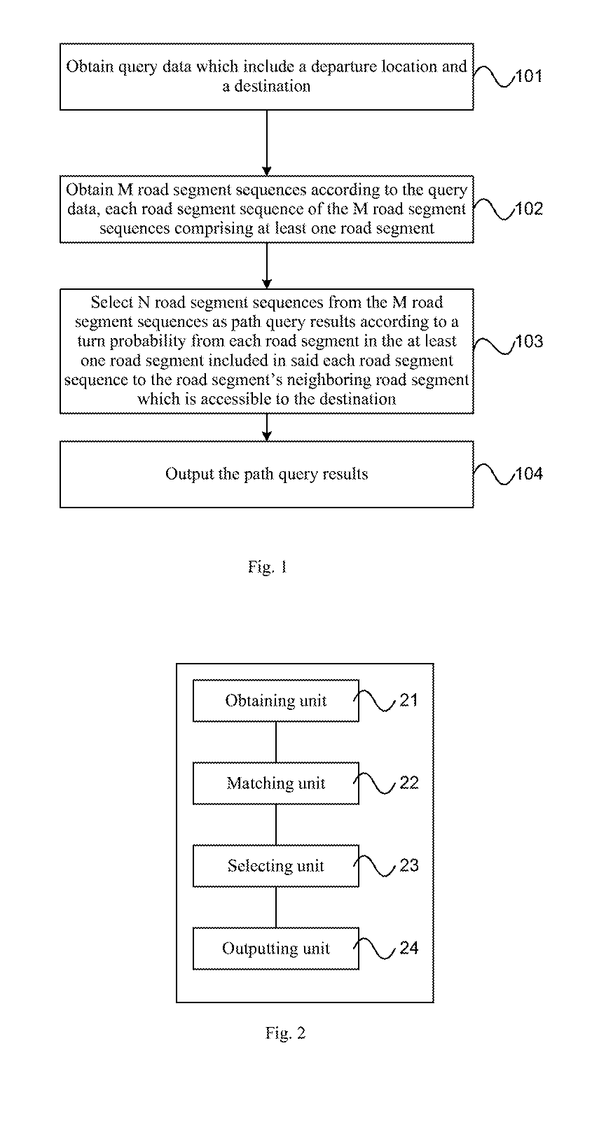

FIG. 1 is a flow chart of a path querying method according to an embodiment of the present disclosure.

101: obtaining query data which include a departure location and a destination.

102: obtaining M road segment sequences according to the query data, each road segment sequence of the M road segment sequences comprising at least one road segment; M being an integer larger than or equal to 2.

The so-called road segment in the field in traffic refers to a transport route between two neighboring nodes on an urban road network. The so-called urban road network refers to a network structure formed by roads which have different functions, classes and district locations, with a certain density and in a suitable form in the urban scope.

The so-called road segment sequence refers to a road segment sequence formed by arranging a series of communicated road segments in an order, and may also be called a path.

103: selecting N road segment sequences from the M road segment sequences as path query results according to a turn probability from each road segment in the at least one road segment included in said each road segment sequence to the road segment's neighboring road segment which is accessible to the destination, N is an integer larger than or equal to 1 and less than or equal to M.

The so-called “accessible to the destination” may mean passing by or through the destination and continuing to move to other places, or considering the destination as a terminal without continuing to move to other places. The present embodiment does not specifically limit in this regard.

104: outputting the path query results.

It needs to be appreciated that all or part of subjects for executing 101-103 may be an application located at a local terminal, or may be a function unit such as a plug-in or Software Development Kit (SDK) located in an application located at the local terminal, or may be an query engine located in the network-side server, or may be a distributed system located on the network side. This is not particularly limited in the present embodiment.

It may be understood that the application may be a native application (nativeAPP) installed on the terminal, or a web application (webAPP) of a browser on the terminal. This is not particularly limited in the present embodiment.

As such, the query data comprising the departure location and destination are obtained, and then the M road segment sequences are obtained according to the query data so that according to the turn probability from each road segment in the at least one road segment included in said each road segment sequence to the road segment's neighboring road segment which is accessible to the destination, N road segment sequences can be selected from the M road segment sequences as the path query results. Since the query-querying operation is performed without depending on the road weights, this can avoid the problem in the prior art about unreasonable query results because the road weights of some roads cannot be updated in time, thereby improving the reliability of the path querying operation.

Usually, some applications involve some path querying services, for example, Baidu map. These applications first display the user a path querying interface so that the user may inputs, then, according to the user-input information, set query endpoint information such as information of endpoints a departure location and a destination, and then request a query engine to provide path data.

Optionally, in a possible implementation mode of the present embodiment, in 101 may be specifically collected a query key word, also called query data, provided by the user.

Specifically, this may be implemented by a query command triggered by the user.

Specifically, the following two manners may be employed to trigger the query command:

Manner 1:

The user may input or select the query key word on a page displayed by the current application, and the query key word may comprise a departure location and a destination. Then, the user clicks a query button on the page to trigger the query command which includes the query key word. As such, after the query command is received, the query key word included therein may be parsed.

Manner 2:

The input content input by the user on the page displayed by the current application is obtained in real time by means of asynchronous uploading technology such as Ajax asynchronous uploading or Jsonp asynchronous uploading. To distinguish from the query key word, the input content at this time may be called input key word. Then, an input character is obtained to trigger the query command which includes the query key word. As such, after the query command is received, the query key word included therein may be parsed. Specifically, an interface such as an Ajax interface or Jsonp interface may be specifically provided. These interfaces may be written in a language such as Java or Hypertext Processor (PHP) language, and its specific invocation may be written by using a language such as Jquery or native JavaScript.

In most cases, since the purpose of the user's query might be random and not specific, the departure location and destination included in the user-provided query data might be uncertain to a certain degree. Therefore, it is feasible to perform proper expansion processing for the departure location and destination included in the query data to expand the scope of the query starting point and query finishing point of the query of this time so that the query starting point is no longer limited to the departure location and the query finishing point is no longer limited to the destination. As such, this can make the query results more conform to the user's real travel intention. in the present disclosure, it is feasible to use an urban road network region to which the departure location included by the query data belongs to expand the departure location, and use an urban road network region to which the destination included by the query data belongs to expand the destination to execute the path querying operation.

The so-called urban road network refers to a network structure formed by roads which have different functions, classes and district locations, with a certain density and in a suitable form in the urban scope.

In this implementation mode, the so-called urban road network region refers to a designated region in the urban road network. These designated regions may be several regions in the urban road network randomly divided based on the urban road network, or may further be several urban road network regions generated by dividing the urban road network and spaced apart a designated distance. This is not specifically limited in the present embodiment.

Optionally, in a possible implementation mode of the present embodiment, in 102, it is specifically feasible to obtain the urban road network region to which the departure location belongs according to the departure location included in the query data, and obtain the urban road network region to which the destination belongs according to the destination included in the query data, and then, perform road segment matching processing in the urban road network according to the urban road network region to which the departure location belongs and the urban road network region to which the destination belongs, to obtain the matched M road segment sequences. The road segments included in each road segment sequence in these road segment sequences all are road segments communicated in turn from the urban road network region to which the departure location belongs to the urban road network region to which the destination belongs, namely, road segments connected end to end. As such, the scope of the query starting point of the query of this time and the query finishing point of the query of this time is expanded so that the query so that the query starting point is no longer limited to the departure location included in the query data and the query finishing point is no longer limited to the destination included in the query data. Therefore, it is possible to obtain more matched road segment sequences and thereby enrich data processing sources on which the path querying operation is based.

A specific method of the road segment matching processing may employ various methods in the prior art. Reference may be made to relevant content in the prior art for detailed depictions, and detailed depictions are not provided any more here.

Optionally, in a possible implementation mode of the present embodiment, in 103, it is specifically to, according to the destination, obtain at least one user historical trajectory for reaching the destination, and then obtain a historical road segment sequence corresponding to each user historical trajectory in the at least one user historical trajectory, then according to the historical road segment sequence corresponding to said each user historical trajectory, obtain a number of first trajectories of passing each road segment included in the historical road segment sequence, and a number of second trajectories of passing the road segment and then passing each neighboring road segment of the road segment, and then, according to the number of first trajectories and the number of second trajectories, obtain a turn probability from each road segment included in the historical road segment sequence to the road segment's each neighboring road segment which is accessible to the destination. For example, a ratio of the number of second trajectories to the number of first trajectories, namely, the number of second trajectories/the number of first trajectories, is considered as the turn probability from each road segment included in the historical road segment sequence to the road segment's each neighboring road segment which is accessible to the destination.

As such, it is feasible to obtain the turn probability from each road segment corresponding to the user historical trajectory in the urban road network to the road segment's each neighboring road segment which is accessible to the destination. However, the turn probability from other road segments in the urban road network to the road segment's each neighboring road segment which is accessible to the destination may be recorded as 0.

The so-called user historical trajectory is a set formed by the user's several trajectory points. In the present disclosure, the user historical trajectory may be matched to the road segment in the urban road network to execute subsequent path querying operation. A specific matching method may employ a matching algorithm in the prior art, for example, Hidden Markov Model. Reference may be made to relevant content in the prior art for detailed depictions, and detailed depictions are not provided any more here.

Similarly, in this implementation mode, the location may be expanded by using the aforesaid location expanding method. Specifically, it is feasible to obtain the urban road network region to which the destination belongs according to the destination, and then, according to the urban road network region to which the destination belongs, obtain at least one user historical trajectory for reaching the urban road network region to which the destination belongs, as at least one user historical trajectory for reaching the destination. As such, since the scope of the query finishing point of the query of this time is expanded so that the query finishing point is no longer limited to the destination, it is possible to obtain more user historical trajectories as the basis for the path querying operation and thereby enrich data sources on which the path querying operation is based.

The expression “at least one user historical trajectory for reaching the urban road network region to which the destination belongs” may mean a user historical trajectory for passing by or through the urban road network region to which the destination belongs and continuing to move to other places, or may mean a user historical trajectory for considering the urban road network region to which the destination belongs as a terminal without continuing to move to other places. The present embodiment does not specifically limit in this regard.

In a specific implementation procedure, it is feasible to form an individual independent road network from road segments corresponding to these user historical trajectories reaching each urban road network region. In this independent road network, each user historical trajectory can reach the urban road network region. If the user historical trajectory is the user historical trajectory for passing by or through a certain urban road network region and continuing to move to other urban road network regions, it is feasible in the independent road network to delete partial paths after said certain urban road network region so that the finishing point of each user historical trajectory in the independent road network is said certain urban road network region.

To improve the efficiency of the path querying operation, the independent road network may be used to index the road segments corresponding to these user historical trajectories. As such, when at least one user historical trajectory for reaching a certain urban road network region is queried according to said certain urban road network region, it is feasible to perform the query directly according to the indices, which can effectively improve the efficiency of the path querying operation.

Optionally, in a possible implementation mode of the present embodiment, in 103, it is specifically feasible to obtain a combined probability of said each road segment sequence according to a turn probability from each road segment in the at least one road segment included in said each road segment sequence to the road segment's neighboring road segment which is accessible to the destination, and then select N road segment sequences from the M road segment sequences as the path query results according to the combined probability of said each road segment sequence.

In this implementation mode, assume that a road segment sequence includes n road segments, namely, link1, link2, . . . , linkn−1, linkn in turn from the departure location (namely, the urban road network region to which the departure location belongs) to the destination (namely, the urban road network region to which the destination belongs), wherein n is an integer larger than or equal to 2. The turn probability of linkn−1 to linkn is expressed as Pₗᵢₙₖₙ, and the combined probability of the road segment sequence may be a product of all turn probabilities and may be expressed by Πⁿᵢ₌₃Pₗᵢₙₖₙ.

In a specific implementation procedure, N road segment sequences with a maximum combined probability may specifically be considered as the path query result. For example, it is specifically feasible to sort all road segment sequences in a descending order of the combined probabilities, and select top N road segment sequences as the query result of the path querying operation.

In another specific implementation procedure, it is specifically feasible to consider a road segment sequence whose combined probability is larger than or equal to a preset probability threshold, as one road segment sequence in the N road segment sequences.

In the present implementation, the query data comprising the departure location and destination are obtained, and then the M road segment sequences are obtained according to the query data so that according to the turn probability from each road segment in the at least one road segment included in said each road segment sequence to the road segment's neighboring road segment which is accessible to the destination, N road segment sequences can be selected from the M road segment sequences as the path query results. Since the query-querying operation is performed without depending on the road weights, this can avoid the problem in the prior art about unreasonable query results because the road weights of some roads cannot be updated in time, thereby improving the reliability of the path querying operation.

In addition, since the user historical trajectory as trajectory big data is employed to execute the path querying operation, the technical solution provided by the present disclosure can be employed to find the user's empirical route, provide more reasonable query results, for example, find a new road, or shun congested road, and substantially improve the user's experience.

As appreciated, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, different emphasis is placed on respective embodiments, and reference may be made to related depictions in other embodiments for portions not detailed in a certain embodiment.

FIG. 2 is a block diagram of a path querying apparatus according to another embodiment of the present disclosure. As shown in FIG. 2, the path querying apparatus in the present embodiment may comprise an obtaining unit 21, a matching unit 22, a selecting unit 23 and an outputting unit 24, wherein the obtaining unit 21 is configured to obtain query data which include a departure location and a destination; the matching unit 22 is configured to obtain M road segment sequences according to the query data, each road segment sequence of the M road segment sequences comprising at least one road segment, M being an integer larger than or equal to 2; the selecting unit 23 is configured to select N road segment sequences from the M road segment sequences as path query results according to a turn probability from each road segment in the at least one road segment included in said each road segment sequence to the road segment's neighboring road segment which is accessible to the destination, N being an integer larger than or equal to 1 and less than or equal to M; the outputting unit 24 is configured to output the path query results.

It needs to be appreciated that all or part of the path querying apparatus according to the present embodiment may be an application located at a local terminal, or may be a function unit such as a plug-in or Software Development Kit (SDK) located in an application located at the local terminal, or may be an query engine located in the network-side server, or may be a distributed system located on the network side. This is not particularly limited in the present embodiment.

It may be understood that the application may be a native application (nativeAPP) installed on the terminal, or a web application (webAPP) of a browser on the terminal. This is not particularly limited in the present embodiment.

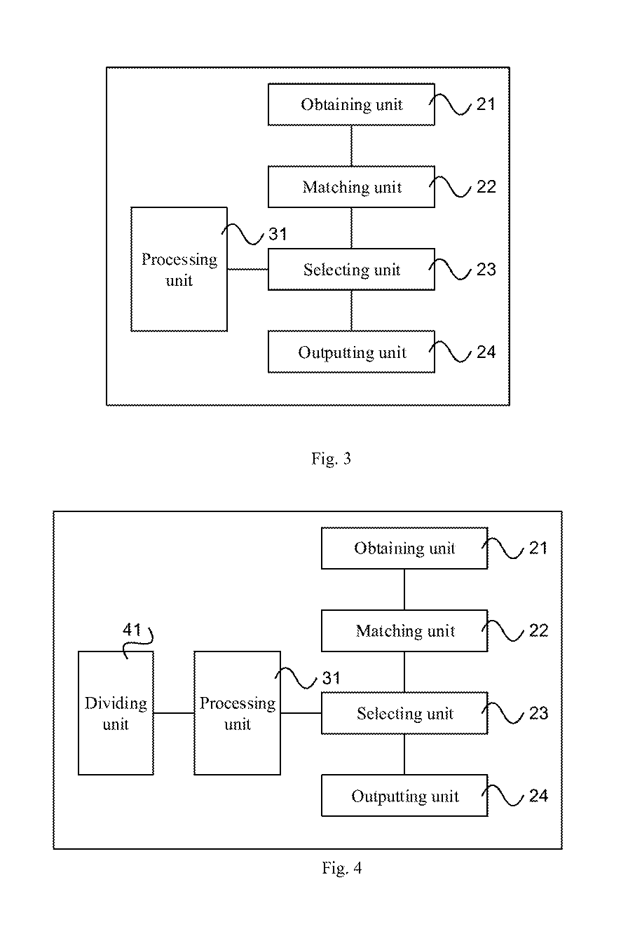

Optionally, in a possible implementation mode of the present embodiment, as shown in FIG. 3, the path querying apparatus according to the present embodiment may further comprise a processing unit 31 configured to obtain at least one user historical trajectory for reaching the destination according to the destination; obtain a historical road segment sequence corresponding to each user historical trajectory in the at least one user historical trajectory; according to the historical road segment sequence corresponding to said each user historical trajectory, obtain a number of first trajectories of passing each road segment included in the historical road segment sequence, and a number of second trajectories of passing the road segment and then passing each neighboring road segment of the road segment; and, according to the number of first trajectories and the number of second trajectories, obtain a turn probability from each road segment included in the historical road segment sequence to the road segment's each neighboring road segment which is accessible to the destination.

Specifically, the processing unit 31 is specifically configured to obtain the urban road network region to which the destination belongs according to the destination; and then, according to the urban road network region to which the destination belongs, obtain at least one user historical trajectory for reaching the urban road network region to which the destination belongs, as at least one user historical trajectory for reaching the destination.

Optionally, in a possible implementation mode of the present embodiment, as shown in FIG. 4, the path querying apparatus according to the present embodiment may further comprise a dividing unit 41 configured to divide the urban road network with a designated spacing to generate several urban road network regions in the urban road network.

Optionally, in a possible implementation mode of the present embodiment, the selecting unit 23 is specifically configured to obtain a combined probability of said each road segment sequence according to a turn probability from each road segment in the at least one road segment included in said each road segment sequence to the road segment's neighboring road segment which is accessible to the destination, and then select N road segment sequences from the M road segment sequences as the path query results according to the combined probability of said each road segment sequence.

In a specific implementation procedure, the selecting unit 23 is specifically configured to consider N road segment sequences with a maximum combined probability as the path query result.

In another specific implementation procedure, the selecting unit 23 is specifically configured to consider a road segment sequence whose combined probability is larger than or equal to a preset probability threshold, as one road segment sequence in the N road segment sequences.

It needs to be appreciated that the method in the embodiment corresponding to FIG. 1 may be implemented by the path querying apparatus according to the present embodiment. Reference may be made to relevant content in the embodiment corresponding to FIG. 1 for detailed description, which will not be detailed any longer here.

In the present embodiment, the obtaining unit obtains the query data comprising the departure location and destination, and then the matching unit obtains the M road segment sequences according to the query data so that the selecting unit selects N road segment sequences from the M road segment sequences as the path query results according to the turn probability from each road segment in the at least one road segment included in said each road segment sequence to the road segment's neighboring road segment which is accessible to the destination. Since the query-querying operation is performed without depending on the road weights, this can avoid the problem in the prior art about unreasonable query results because the road weights of some roads cannot be updated in time, thereby improving the reliability of the path querying operation.

In addition, since the user historical trajectory as trajectory big data is employed to execute the path querying operation, the technical solution provided by the present disclosure can be employed to find the user's empirical route, provide a more reasonable query result, for example, find a new road, or shun congested road, and substantially improve the user's experience.

Those skilled in the art can clearly understand that for purpose of convenience and brevity of depictions, reference may be made to corresponding procedures in the aforesaid method embodiments for specific operation procedures of the system, apparatus and units described above, which will not be detailed any more.

In the embodiments provided by the present disclosure, it should be understood that the revealed system, apparatus and method can be implemented in other ways. For example, the above-described embodiments for the apparatus are only exemplary, e.g., the division of the units is merely logical one, and, in reality, they can be divided in other ways upon implementation. For example, a plurality of units or components may be combined or integrated into another system, or some features may be neglected or not executed. In addition, mutual coupling or direct coupling or communicative connection as displayed or discussed may be indirect coupling or communicative connection performed via some interfaces, means or units and may be electrical, mechanical or in other forms.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, read-only memory (ROM), a random access memory (RAM), magnetic disk, or an optical disk.

Finally, it is appreciated that the above embodiments are only used to illustrate the technical solutions of the present disclosure, not to limit the present disclosure; although the present disclosure is described in detail with reference to the above embodiments, those having ordinary skill in the art should understand that they still can modify technical solutions recited in the aforesaid embodiments or equivalently replace partial technical features therein; these modifications or substitutions do not make essence of corresponding technical solutions depart from the spirit and scope of technical solutions of embodiments of the present disclosure.

1.-14. (canceled)

15. A path querying method, wherein the method comprises:
obtaining query data which include a departure location and a destination;
obtaining M road segment sequences according to the query data, each road segment sequence in the M road segment sequences comprising at least one road segment, M being an integer larger than or equal to 2;
selecting N road segment sequences from the M road segment sequences as path query results according to a turn probability from each road segment in the at least one road segment included in said each road segment sequence to the road segment's neighboring road segment which is accessible to the destination, N being an integer larger than or equal to 1 and less than or equal to M;
outputting the path query results.

16. The method according to claim 15, wherein before selecting N road segment sequences from the M road segment sequences as path query results according to a turn probability from each road segment in the at least one road segment included in said each road segment sequence to the road segment's neighboring road segment which is accessible to the destination, the method further comprises:
obtaining at least one user historical trajectory for reaching the destination according to the destination;
obtaining a historical road segment sequence corresponding to each user historical trajectory in the at least one user historical trajectory;
according to the historical road segment sequence corresponding to said each user historical trajectory, obtaining the number of first trajectories of passing each road segment included in the historical road segment sequence, and the number of second trajectories of passing the road segment and then passing each neighboring road segment of the road segment; and
according to the number of first trajectories and the number of second trajectories, obtaining a turn probability from each road segment included in the historical road segment sequence to the road segment's each neighboring road segment which is accessible to the destination.

17. The method according to claim 16, wherein the obtaining at least one user historical trajectory for reaching the destination according to the destination comprises:
obtaining an urban road network region to which the destination belongs according to the destination; and
according to the urban road network region to which the destination belongs, obtaining at least one user historical trajectory for reaching the urban road network region to which the destination belongs, as at least one user historical trajectory for reaching the destination.

18. The method according to claim 17, wherein before obtaining an urban road network region to which the destination belongs according to the destination, the method further comprises:
dividing the urban road network with a designated spacing to generate several urban road network regions in the urban road network.

19. The method according to claim 15, wherein the selecting N road segment sequences from the M road segment sequences as path query results according to a turn probability from each road segment in the at least one road segment included in said each road segment sequence to the road segment's neighboring road segment which is accessible to the destination comprises:
obtaining a combined probability of said each road segment sequence according to the turn probability from each road segment in the at least one road segment included in said each road segment sequence to the road segment's neighboring road segment which is accessible to the destination;
selecting N road segment sequences from the M road segment sequences as the path query results according to the combined probability of said each road segment sequence.

20. The method according to claim 19, wherein the selecting N road segment sequences from the M road segment sequences as the path query results according to the combined probability of said each road segment sequence comprises:
considering N road segment sequences with a maximum combined probability as the path query results; or
considering a road segment sequence whose combined probability is larger than or equal to a preset probability threshold, as one road segment sequence in the N road segment sequences.

21. A device, comprising
one or more processors;
a memory;
one or more programs stored in the memory and configured to execute the following operation when executed by the one or more processors:
obtaining query data which include a departure location and a destination;
obtaining M road segment sequences according to the query data, each road segment sequence in the M road segment sequences comprising at least one road segment, M being an integer larger than or equal to 2;
selecting N road segment sequences from the M road segment sequences as path query results according to a turn probability from each road segment in the at least one road segment included in said each road segment sequence to the road segment's neighboring road segment which is accessible to the destination, N being an integer larger than or equal to 1 and less than or equal to M;
outputting the path query results.

22. The device according to claim 21, wherein before selecting N road segment sequences from the M road segment sequences as path query results according to a turn probability from each road segment in the at least one road segment included in said each road segment sequence to the road segment's neighboring road segment which is accessible to the destination, the operation further comprises:
obtaining at least one user historical trajectory for reaching the destination according to the destination;
obtaining a historical road segment sequence corresponding to each user historical trajectory in the at least one user historical trajectory;
according to the historical road segment sequence corresponding to said each user historical trajectory, obtaining the number of first trajectories of passing each road segment included in the historical road segment sequence, and the number of second trajectories of passing the road segment and then passing each neighboring road segment of the road segment; and
according to the number of first trajectories and the number of second trajectories, obtaining a turn probability from each road segment included in the historical road segment sequence to the road segment's each neighboring road segment which is accessible to the destination.

23. The device according to claim 22, wherein the operation of obtaining at least one user historical trajectory for reaching the destination according to the destination comprises:
obtaining an urban road network region to which the destination belongs according to the destination; and
according to the urban road network region to which the destination belongs, obtaining at least one user historical trajectory for reaching the urban road network region to which the destination belongs, as at least one user historical trajectory for reaching the destination.

24. The device according to claim 23, wherein before obtaining an urban road network region to which the destination belongs according to the destination, the operation further comprises:
dividing the urban road network with a designated spacing to generate several urban road network regions in the urban road network.

25. The device according to claim 21, wherein the operation of selecting N road segment sequences from the M road segment sequences as path query results according to a turn probability from each road segment in the at least one road segment included in said each road segment sequence to the road segment's neighboring road segment which is accessible to the destination comprises:
obtaining a combined probability of said each road segment sequence according to the turn probability from each road segment in the at least one road segment included in said each road segment sequence to the road segment's neighboring road segment which is accessible to the destination;
selecting N road segment sequences from the M road segment sequences as the path query results according to the combined probability of said each road segment sequence.

26. The device according to claim 25, wherein the operation of selecting N road segment sequences from the M road segment sequences as the path query results according to the combined probability of said each road segment sequence comprises:
considering N road segment sequences with a maximum combined probability as the path query results; or
considering a road segment sequence whose combined probability is larger than or equal to a preset probability threshold, as one road segment sequence in the N road segment sequences.

27. A non-volatile computer storage medium in which one or more programs are stored, an apparatus being enabled to execute the following operation when said one or more programs are executed by the apparatus:
obtaining query data which include a departure location and a destination;
obtaining M road segment sequences according to the query data, each road segment sequence of the M road segment sequences comprising at least one road segment, M being an integer larger than or equal to 2;
selecting N road segment sequences from the M road segment sequences as path query results according to a turn probability from each road segment in the at least one road segment included in said each road segment sequence to the road segment's neighboring road segment which is accessible to the destination, N being an integer larger than or equal to 1 and less than or equal to M;
outputting the path query results.

28. The non-volatile computer storage medium according to claim 27, wherein before selecting N road segment sequences from the M road segment sequences as path query results according to a turn probability from each road segment in the at least one road segment included in said each road segment sequence to the road segment's neighboring road segment which is accessible to the destination, the operation further comprises:
obtaining at least one user historical trajectory for reaching the destination according to the destination;
obtaining a historical road segment sequence corresponding to each user historical trajectory in the at least one user historical trajectory;
according to the historical road segment sequence corresponding to said each user historical trajectory, obtaining the number of first trajectories of passing each road segment included in the historical road segment sequence, and the number of second trajectories of passing the road segment and then passing each neighboring road segment of the road segment; and
according to the number of first trajectories and the number of second trajectories, obtaining a turn probability from each road segment included in the historical road segment sequence to the road segment's each neighboring road segment which is accessible to the destination.

29. The non-volatile computer storage medium according to claim 28, wherein the operation of obtaining at least one user historical trajectory for reaching the destination according to the destination comprises:
obtaining an urban road network region to which the destination belongs according to the destination; and
according to the urban road network region to which the destination belongs, obtaining at least one user historical trajectory for reaching the urban road network region to which the destination belongs, as at least one user historical trajectory for reaching the destination.

30. The non-volatile computer storage medium according to claim 29, wherein before obtaining an urban road network region to which the destination belongs according to the destination, the operation further comprises:
dividing the urban road network with a designated spacing to generate several urban road network regions in the urban road network.

31. The non-volatile computer storage medium according to claim 27, wherein the operation of selecting N road segment sequences from the M road segment sequences as path query results according to a turn probability from each road segment in the at least one road segment included in said each road segment sequence to the road segment's neighboring road segment which is accessible to the destination comprises:
obtaining a combined probability of said each road segment sequence according to the turn probability from each road segment in the at least one road segment included in said each road segment sequence to the road segment's neighboring road segment which is accessible to the destination;
selecting N road segment sequences from the M road segment sequences as the path query results according to the combined probability of said each road segment sequence.

32. The non-volatile computer storage medium according to claim 31, wherein the operation of selecting N road segment sequences from the M road segment sequences as the path query results according to the combined probability of said each road segment sequence comprises:
considering N road segment sequences with a maximum combined probability as the path query results; or
considering a road segment sequence whose combined probability is larger than or equal to a preset probability threshold, as one road segment sequence in the N road segment sequences.
